(19) United States
(12) Patent Application Publication
(10) Pub. No.: US 2023/0130535 A1
(43) Pub. Date: Apr. 27, 2023

(54) User Representations in Artificial Reality

(71) Applicant: Meta Platforms Technologies, LLC, Menlo Park, CA (US)

(72) Inventors: Jing MA, Mill Creek, WA (US); Paul Armistead HOOVER, Bothell, WA (US); Joshuah VINCENT, Seattle, WA (US); Tali ZVI, San Carlos, CA (US); Hyunbin PARK, Redwood City, CA (US); Michal HLAVAC, Seattle, WA (US); Kiryl KLIUSHKIN, Mountain View, CA (US); William WONG, Poughquag, NY (US)

(21) Appl. No.: 17/936,884

(22) Filed: Sep. 30, 2022

Related U.S. Application Data
(60) Provisional application No. 63/348,609, filed on Jun. 3, 2022.
(60) Provisional application No. 63/325,333, filed on Mar. 30, 2022.
(60) Provisional application No. 63/325,343, filed on Mar. 30, 2022.
(60) Provisional application No. 63/303,184, filed on Jan. 26, 2022.

(51) Int. Cl. G06T 13/40; G06T 19/00; H04N 7/15

(52) U.S. Cl. CPC G06T 13/40; G06T 19/006; H04N 7/157; G06T 2213/12

(57) ABSTRACT

The disclosed technology can execute rules for an ambient avatar to perform physical interactions based on a status of a represented user and/or a context of a viewing user. The disclosed technology can further evaluate and select movement points that support avatar movement in an artificial reality environment. The disclosed technology can yet further detect trigger conditions and transition a user presence in a shared communication session. And the disclosed technology can generate stylized 3D avatars from 2D images.

### CROSS REFERENCE TO RELATED APPLICATIONS

This application claims priority to U.S. Provisional Application Nos. 63/303,184 filed Jan. 26, 2022 and titled “Translating Statuses Into Physical Interactions for Ambient Avatars,” 63/325,333 filed Mar. 30, 2022 and titled “Selecting Movement Points to Support Avatar Movement in Artificial Reality,” 63/325,343 filed Mar. 30, 2022 and titled “User Presence Transitions Based on Trigger Detection,” and 63/348,609 filed Jun. 3, 2022 and titled “Stylized Three-Dimensional Avatar Pipeline.” Each patent application listed above is incorporated herein by reference in their entireties.

### BACKGROUND

Artificial reality systems can display virtual objects in a variety of ways, such as by making them “world-locked” or “body locked.” World-locked virtual objects are positioned so as to appear stationary in the world, even when the user moves around in the artificial reality environment. Body-locked virtual objects are positioned relative to the user of the artificial reality system, so as to appear at the same position relative to the user's body, despite the user moving around the artificial reality environment. In some cases, a user can be represented by an artificial reality system with an avatar virtual object, which can have features chosen by that user and may or may not resemble that user.

Artificial reality devices have grown and popularity with users, and this growth is predicted to accelerate. In many artificial reality environments, the user's presence is represented by an avatar. The avatar's movements can be controller by the user, for example using one or more control devices (e.g., a joystick), based on devices and sensors that sense the user's movements (e.g., cameras, wearable sensors), or a combination of these. Avatar movement can be supported by a variety of different structures and models.

Computing devices spread across geographic regions are becoming increasingly connected. Users of these computing devices are able to communicate in increasingly sophisticated ways, such as through a video call, augmented reality, and other environments. However, the presence a user displays during these communication sessions is often static, and traditional presentation techniques fail to keep up with pace of technological progress.

Artificial reality (XR) devices such as head-mounted displays (e.g., smart glasses, VR/AR headsets), mobile devices (e.g., smartphones, tablets), projection systems, “cave” systems, or other computing systems can present an artificial reality environment where users can interact with “virtual objects” (i.e., computer-generated object representations appearing in an artificial reality environment) alongside representations of other users, such as “avatars.” Existing XR systems allow users to interact with these virtual objects and avatars in 3D space to create an immersive experience. Some XR systems produce photorealistic virtual environments, while others produce stylized or artistic representations of objects and users in a virtual environment.

In some systems, a user's avatar in a XR environment may be a predetermined or user-configured 3D model of a person or character. Although the number of configurable characteristics may vary, such systems have a finite number of characteristic combinations that produce a limited number of possible avatars. Moreover, providing a limited set of configurable characteristics may result in avatars that do not closely resemble the likeness of a particular person. As a result, it can be difficult for users to visually identify a particular person in an XR environment based only on that person's avatar.

### SUMMARY

Aspects of the present disclosure are directed to an ambient avatar system that can place an ambient avatar in an environment for a user (a “viewing user”) where the ambient avatar represents another user (the “represented user”), whether or not the represented user is in direct control of the ambient avatar. The ambient avatar system can then execute rules for the ambient avatar to perform physical interactions based on the status of the represented user and/or the context of the viewing user. Such statuses can include, for example, what messages or communications the represented user has sent, whether the represented user is actively controlling the ambient avatar, an active/available state of the represented user, a determined emotional state of the represented user, etc. Examples of the viewing user's contexts can include where the viewing user is looking, the viewing user's physical pose or motions, a current activity determined for the viewing user, a social connection level between the viewing user and the represented user, etc. The ambient avatar's rules can the cause the ambient avatar to perform actions such as handing a pending message to the viewing user, giving the viewing user a high five, waiving its arms at the viewing user, etc.

Additional aspects of the present disclosure are directed to a framework for evaluating and selecting movement points for supporting avatar movement in an artificial reality environment. A selection component can perform avatar movement analysis to select candidate movement points that support avatar movement in artificial reality. An evaluation component can evaluate avatar movement according to the selected candidate movement points. For example, the evaluation component can evaluate movement fidelity for avatar movement using the candidate movement points and a resource metric (e.g., predicted computing resource usage at a client device) when computing avatar movement using the candidate movement points. In some implementations, multiple iterations of candidate movement points can be selected and evaluated. For example, the candidate movement points can be ranked according to an evaluation metric. One or more sets of candidate movements points can be selected as production movement points based on the ranking.

Further aspects of the present disclosure are directed to a diverse set of user presence representations during a joint communication session (e.g., video call). A presence manager can transition between a diverse set of user presence representations, such as a still image, avatar, mini-avatar, two-dimensional video, and three-dimensional hologram. The presence manager can perform a presence transition upon detection of a trigger. For example, when a portion of a user moves out of frame the presence manager can transition to an avatar representations for the portion of the user that is not in frame. In another example, the presence manager can transition a hologram presence to a two-dimensional video when the user moves a certain distance from an image capturing device. In another example, the presence manager can reduce the fidelity of a hologram presence or transition to an avatar presence based on system resources availability and network bandwidth. In some implementations, defined zone locations can have predefined presence associations (e.g., display to an avatar when not at home, display a still image when in the bathroom). In another example, certain activities can also include predefined associations (e.g., when a driving or “on the go” activity is detected, transition to a mini-avatar presence).

Yet further aspects of the present disclosure are directed to generating stylized three-dimensional (3D) avatars of a person from two-dimensional (2D) images using a pipeline or cascade of one or more transformations. A first transformation involves converting a 2D image of a person into a stylized version of the 2D image of that person using a generative artificial intelligence (AI) model. The generative AI model may be trained to stylize the person to match a particular aesthetic or artistic style. The pipeline then infers a depth map based on the stylized version of the 2D image of the person using an algorithm and/or AI model, which is used to generate a stylized 3D avatar. The stylized 3D avatar may be used to represent a person in artificial reality (XR) environments, such as in virtual reality (VR) or as augmented or mixed reality (AR/MR) environments.

### BRIEF DESCRIPTION OF THE DRAWINGS

FIG. 1 is an example of an ambient avatar performing an action to hand a virtual object for an incoming message to a viewing user.

FIG. 2 is an example of an ambient avatar performing an action to notify a viewing user that the user the ambient avatar represents is calling them.

FIG. 3 is a flow diagram illustrating a process used in some implementations for causing an ambient avatar to perform physical interactions.

FIG. 4 depicts a diagram of an example user body and avatar with candidate movement points.

FIG. 5 depicts a system diagram of example components for evaluating and selecting movement points that support avatar movement in an artificial reality environment.

FIG. 6 is a flow diagram illustrating a process used in some implementations for evaluating and selecting movement points that support avatar movement in an artificial reality environment.

FIG. 7 depicts a diagram of example user presence representations including a still image, a mini-avatar, and a two-dimensional video.

FIG. 8 depicts a diagram of example user presence representations including an avatar and a three-dimensional hologram video.

FIG. 9 is a flow diagram illustrating a process 300 used in some implementations for detecting trigger conditions and transitioning a user presence in a shared communication session.

FIG. 10 is a conceptual diagram illustrating an example transformation of an image of a user to a stylized 3D avatar.

FIG. 11 is a conceptual diagram illustrating an example transformation of an image of a user to a stylized 3D avatar.

FIG. 12 is a conceptual diagram illustrating an example transformation of an image of a user to a stylized 3D avatar.

FIG. 13 is a conceptual diagram illustrating example transformations of images of a user to stylized 3D avatars.

FIG. 14 is a flow diagram illustrating a process used in some implementations of the present technology for generating stylized 3D avatars.

FIG. 15 is a flow diagram illustrating a process used in some implementations of the present technology for transferring user characteristics to a stylized 3D avatars.

FIG. 16 is a block diagram illustrating an overview of devices on which some implementations of the present technology can operate.

FIG. 17 is a block diagram illustrating an overview of an environment in which some implementations of the present technology can operate.

### DESCRIPTION

Interactions between users while in an artificial reality environment can be impersonal and can feel like they are just a recreation of flat-panel interactions. However, interactions with others through an artificial reality device should take advantage of the capabilities that artificial reality devices offer, such as the ability to represent 3D objects, user movement tracking, and the ability to understand the user's context. One way to achieve better inter-user interactions is with ambient avatars. A user (a “viewing user”) can place an ambient avatar that represents another user (the “represented user”) in her environment, which can remain there whether or not the represented user is in direct control of the ambient avatar. An ambient avatar system can then execute rules for the ambient avatar to perform physical interactions based on the status of the represented user and/or the context of the viewing user. Thus, the ambient avatar can understand the context of the environment and associated users to perform physical interactions. For example, a message may be available through the ambient avatar, and instead of just showing up as a static virtual object, the viewing user can reach out to the ambient avatar who hands a virtual object representing the message to the viewing user.

The ambient avatar system can determine represented user statuses from e.g., access to a messaging platform, a social media platform, data the represented user volunteers an artificial reality device (worn by the represented user) to gather, etc. For example, the ambient avatar system can obtain indications of messages or communications (e.g., incoming voice of video calls) from the represented user to the viewing user, whether the represented user is actively controlling the ambient avatar, whether the represented user has an active or available state, a determined emotional state of the represented user (e.g., based on facial expressions, social media status posts, messaging expressions, etc.), whether the represented user has seen a message sent by the viewing user, etc.

The ambient avatar system can also determine a context for the viewing user, e.g., through contextual information that the viewing user volunteered an artificial reality device (worn by the viewing user) to gather, the viewing user's interactions with a social media platform, additional mapping data (e.g., simultaneous localization and mapping or SLAM data) gathered for the user, etc. Examples of the viewing user's contexts can include where the viewing user is looking, the viewing user's physical pose or motions, a current activity determined for the viewing user, whether the viewing user is attempting to interact with the ambient avatar, a connection between the viewing user and the represented user, etc.

The ambient avatar's rules can the cause the ambient avatar to perform actions. For example, the ambient avatar can hand a pending message from the represented user to the viewing user. As another example, the ambient avatar can perform a “high five” interaction with the viewing user when the ambient avatar system detects the viewing user making a high five gesture near the ambient avatar. As a further example, the ambient avatar can determine that the represented user is making a call to the viewing user and can wave its arms and present an icon indicating the incoming call. In yet another example, the ambient avatar system can determine when the viewing user is speaking toward the ambient avatar and, in response, can cause the ambient avatar to perform active listening movements such as making eye contact and nodding along.

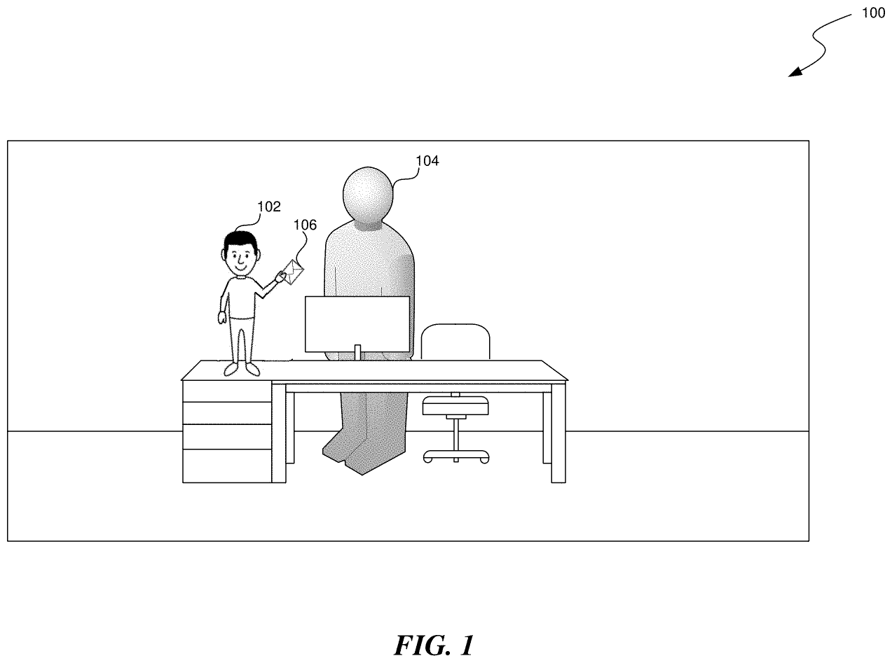

FIG. 1 is an example 100 of an ambient avatar performing an action to hand a virtual object for an incoming message to a viewing user. Example 100 illustrates an ambient avatar 102 that a viewing user 104 has pinned to her desk. The user represented by the ambient avatar 102 has sent a message to viewing user 104. In response to such a message having been received and the viewing user 104 being within a threshold distance of the ambient avatar 102, the ambient avatar 102 has held up a virtual object 106 representing the message, which the viewing user 104 can take from the ambient avatar 102 and perform actions on such as opening it to read the message.

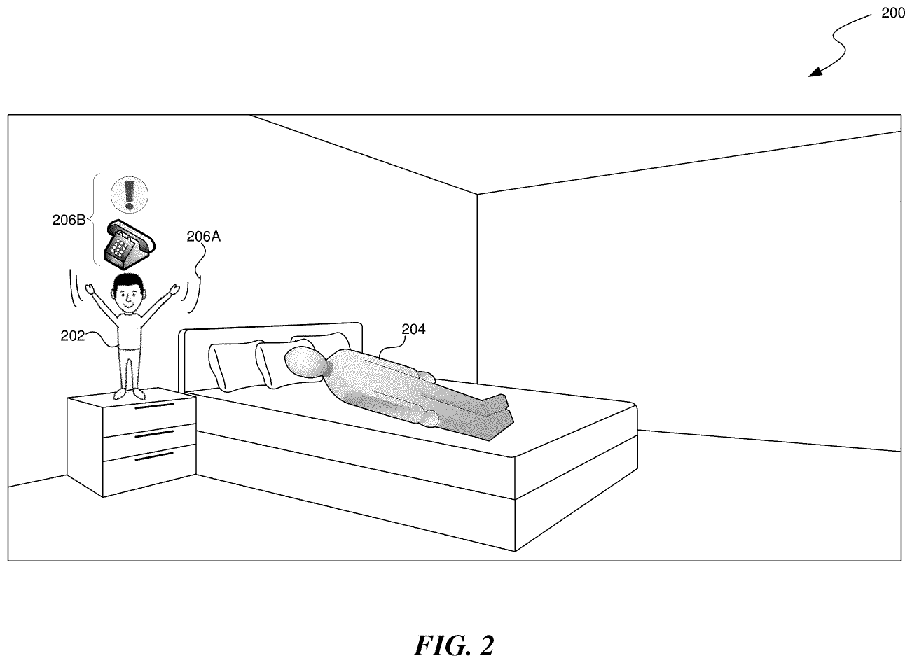

FIG. 2 is an example 200 of an ambient avatar performing an action to notify a viewing user that the user the ambient avatar represents is calling them. Example 200 illustrates an ambient avatar 202 that a viewing user 204 has pinned to her bedside table. The user represented by the ambient avatar 202 is making a call to viewing user 204. In response to this call coming in, the ambient avatar 202 is waiving its hands (as indicated by movement lines 206A) and is presenting icons 206B representing the incoming call, which the viewing user 204 can interact with to accept the call (the call, for example, may then be performed by speaking to the ambient avatar 202).

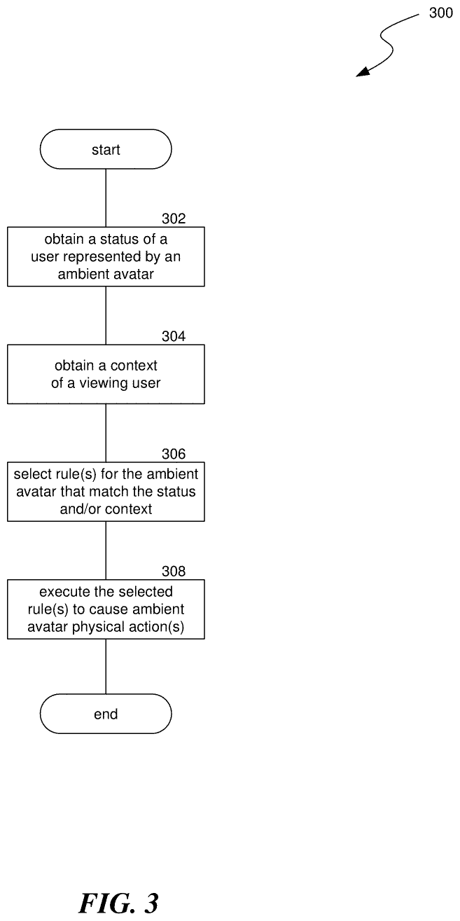

FIG. 3 is a flow diagram illustrating a process 300 used in some implementations for causing an ambient avatar to perform physical interactions. In various implementations, process 300 can be performed on an artificial reality device providing an ambient avatar or on a server providing ambient avatar instructions to such an artificial reality device. In some cases, process 300 can be performed in response to a viewing user selecting an ambient avatar to be presented in her artificial reality environment, causing the artificial reality device to begin checking for whether physical interaction rules of the ambient avatar are triggered.

At block 302, process 300 can obtain a status of a user represented by an ambient avatar. An ambient avatar can be added to a viewing user's artificial reality environment, e.g., when the viewing user selects the represented user (such as from a contact list, message, etc.) and drags or otherwise pins the selected represented user to an anchor point. Process 300 can receive updates on a status of the user represented by the ambient avatar. These statuses can be information volunteered or authorized by the represented user to be shared, such as social medial posts, messaging content/status, location, activities, etc. that can be observed by a social media platform, messaging system, artificial reality device, etc. In various implementations, the status can include, for example, indications of messages or communications (e.g., incoming voice of video calls) from the represented user to the viewing user, whether the represented user is actively controlling the ambient avatar, whether the represented user has an active or available state, a determined emotional state of the represented user (e.g., based on facial expressions, social media status posts, messaging expressions, etc.), whether the represented user has seen a message sent by the viewing user, etc.

At block 304, process 300 can obtain a context of a viewing user. Similarly to the represented user's state, the viewing user's context can be information volunteered or authorized by the viewing user to be shared, that is then obtained from a social media platform, messaging system, artificial reality device, etc. The viewing user context can include information about the environment the ambient avatar is placed in, the physical state (e.g., pose, motion, gestures, gaze direction, location, etc.) of the viewing user, current activities (e.g., reading, laughing, talking, cooking, relaxing, etc.) of the viewing user, whether the viewing user is attempting to interact with the ambient avatar, a connection (e.g., on a social graph) between the viewing user and the represented user, other data about the viewing user from a social graph, an emotional state of the viewing user (e.g., happy, sad, excited, nervous, etc.), or other contextual items. For example, the context can indicate whether the viewing user is within two feet of the ambient avatar, whether the viewing user has a hand up, what pose the viewing user's hand is in, etc.

At block 306, process 300 can select rule(s) defined for the ambient avatar that uses value(s) from the status and/or context as parameters. For example, a rule can include a definition of one or more status and/or context values that match types assigned to the status and/or context values obtained at block 302 and/or 304. When a rule has defined one or more of these obtained status and/or context value types, that rule can be selected.

The following are examples of such rules, but there are many other rules that could be defined. A first rule could include parameters for the availability status of the represented user and the gaze direction of the viewing user and when that represented user status indicates the represented user is available the ambient avatar can make eye contact with the viewing user (using the viewing user's gaze information) and when that represented user status indicates the represented user is not available can cause the ambient avatar to perform a non-interaction motion such as showing itself as sitting down, sleeping, etc.

A second rule could include parameters for a represented user status of having sent a message (e.g., email, IM, text, etc.) to the viewing user, the viewing user hasn't yet received it, and the viewing user is withing a threshold distance of the ambient avatar; which can cause the ambient avatar to take a physical action of holding up a virtual object, representing the message, for the viewing user to take from the ambient avatar's hand.

A third rule could include parameters for an emotional state of the represented user (e.g., determined through an explicit selection of the represented user or inferred from messages, social media posts, etc. from the represented user) and a gaze direction of the viewing user; the rule can map various emotional states to physical ambient avatar actions (e.g., jumping for joy, crying, slumping shoulders, laughing, etc.) which the ambient avatar can perform when the viewing user's gaze is on the ambient avatar.

A fourth rule could include parameters for the viewing user being within a threshold distance of the ambient avatar and having her hand raised with her palm flat (e.g., in a high five gesture); which the rule can map to having the ambient avatar also raise its hand to give the viewing user a high five, which when performed by the viewing user, an indication of the high five can be sent to the represented user.

A fifth rule could include parameters for the represented user attempting to make a call or otherwise initiate a live communication with the viewing user; which when true, can cause the ambient avatar to take an action such as waiving its hands in the air, moving toward the viewing user, miming making a call, presenting an incoming call icon, etc.

A sixth rule could include parameters for whether the viewing user is speaking and whether the viewing user's gaze is on the ambient avatar; this rule can cause the ambient avatar to perform active listening actions such as making eye contact with the viewing user, nodding along to the conversation, making hand gestures, etc. and can also have the system provide a notification of the message from the viewing user to the represented user.

A seventh rule could include parameters for whether the user is in one of a set of communication modes; this rule can cause the ambient avatar to transition into a corresponding avatar version. For example, if the suer is in a synchronous communication mode (e.g., a holographic call, a video call, an audio call, etc.), the ambient avatar can transform into a full-size live avatar. In various implementations, rules can be predefined in the system or users can define their own triggers and actions as a rule.

In various implementations, the actions that a rule an avatar can take, as invoked by a rule, can be a set of pre-defined actions (e.g., from an action library) or can be user-defined actions. As examples of a user-defined actions, a user may define a movement pattern through scripting, by making motions with their own body that the system can record to have the avatar mimic, or by defining movements in a 3D modeling application. Specific examples of such user-defined actions can include, a custom facial expression, dance moves, a hand gesture, etc.

At block 308, process 300 can execute the selected rule(s) to cause the ambient avatar to perform physical action(s) defined by the rule, as discussed above. Process 300 can then end.

Implementations evaluate and select movement points that support avatar movement in an artificial reality environment. For example, a movement point framework can iteratively select sets of candidate movement points and evaluate the sets of candidate movement points to generate an evaluation metric for the sets. Using the evaluation metrics, the sets of candidate movements points can be ranked and one or more sets can be selected for production.

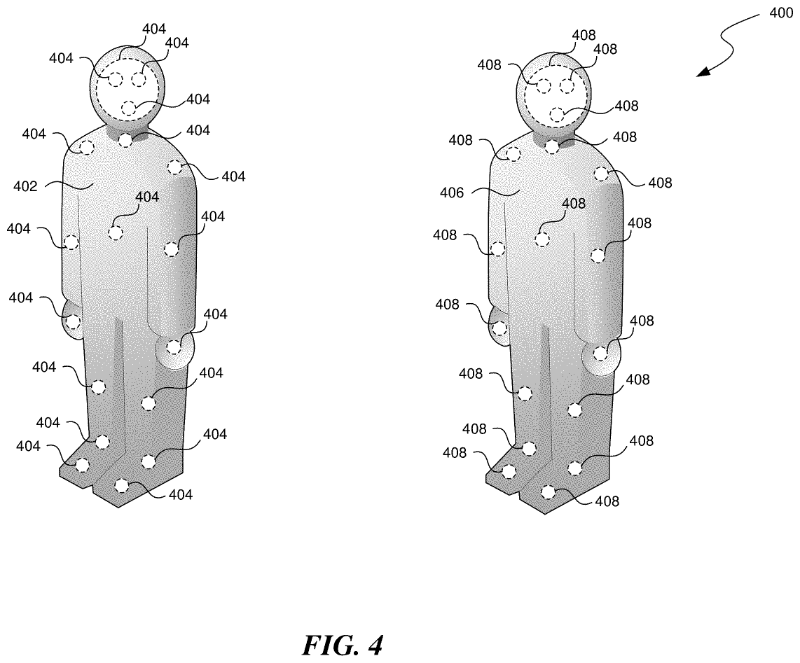

FIG. 4 depicts a diagram of an example user body and avatar with candidate movement points. Diagram 400 depicts user body 402, candidate movement points 404, avatar 406, and candidate movement points 408. Candidate movement points 404 can be points that correspond to tracked movement on user body 402. For example, an artificial reality system can include sensors (e.g., cameras, wearable sensors, such as head mounted sensors, wrist sensors, etc., hand-held sensors, and the like) for detecting user movement. Candidate movement points 404 can represent points tracked on user body 402 that can correspond to candidate movement points 408 on avatar 406.

For example, a body model for avatar 406 can include a three-dimensional volume representation of the avatar's body. In some implementations, an avatar body model can include a frame or skeleton with joints (e.g., elbows, ankles, knees, neck, and the like). The candidate movement points 408 on avatar 406 that correspond to candidate movement points 404 on user body 402 can be controlled/coordinated to achieve avatar movement. Correspondence between the sensed movement of user body 402 according to candidate movement points 404 and the controlled movement of avatar 406 using corresponding candidate movement points 408 can achieve avatar motion that simulates the user's presence in an artificial reality environment.

In some implementations, candidate movement points 404 of user body 402 can be mapped to candidate movement points 408 on avatar 406. For example, avatar body models can differ from the body of a user. A mapping technique can be used to map the locations of candidate movement points 404 on user body 402 to the candidate movement points 408 on the body model of avatar 406. In some implementations, the relative locations of candidate movement points 404 on user body 402 can be determined by one or more mappings techniques. These relative locations can then be mapped to relative locations on a body model of avatar 406 to locate candidate movement points 408.

Implementations can select sets of candidate movement points 404 on user body 402 to support avatar movement using corresponding sets of candidate movement points 408 on avatar 406. An example set of candidate movement points 404 can include the head, eyes, mouth, hands, and center of mass of user body 402. Other example candidate movement points include neck, shoulders, elbows, knees, ankles, feet, legs (e.g., upper leg and/or lower leg), arms (e.g., upper arm and/or lower arm), and the like. Any suitable combination of candidate movement points 404 can be selected as a set of candidate movement points.

Based on the movement points selected for tracking/sensing, avatar 406 can simulate user body 402's movements with different fidelity levels. Example types of simulated user body movements include facial expressiveness (e.g., eye movement, such as pupil movement, winking, blinking, eyebrow movement, neutral expressions, mouth movements/lip synchronization, non-verbal facial mouth movements, forehead expressions, cheek expressions, etc.), body and hand movements (e.g., movements of the torso and upper-body, body orientation relative to anchor point, hand tracking, shoulder movements, torso twisting, etc.), user action movements (e.g., simulated talking using facial expressions, simulated jumping, simulated kneeling/ducking, simulated dancing, etc.), and other suitable user body movements.

In some implementations, movement of avatar 406 can also be triggered by detection that the user is occupied with another activity, client application, attending an event, or detection of any other suitable user distraction or event that has the user's attention. For example, upon detection of a user distraction, avatar 406 can be controlled to perform a default movement, system generated movement (e.g., artificial intelligence controlled movement), or any other suitable movement. Movement of avatar 406 can also be triggered by audio (i.e., user is laughing out loud, singing, etc.) or haptic feedback. For example, one or more sensors can detect laughing or singing by the user and avatar 406 can be controlled to perform facial movements that correspond to the detected audio. The movement points selected for a given avatar body model can impact the fidelity of these avatar movements.

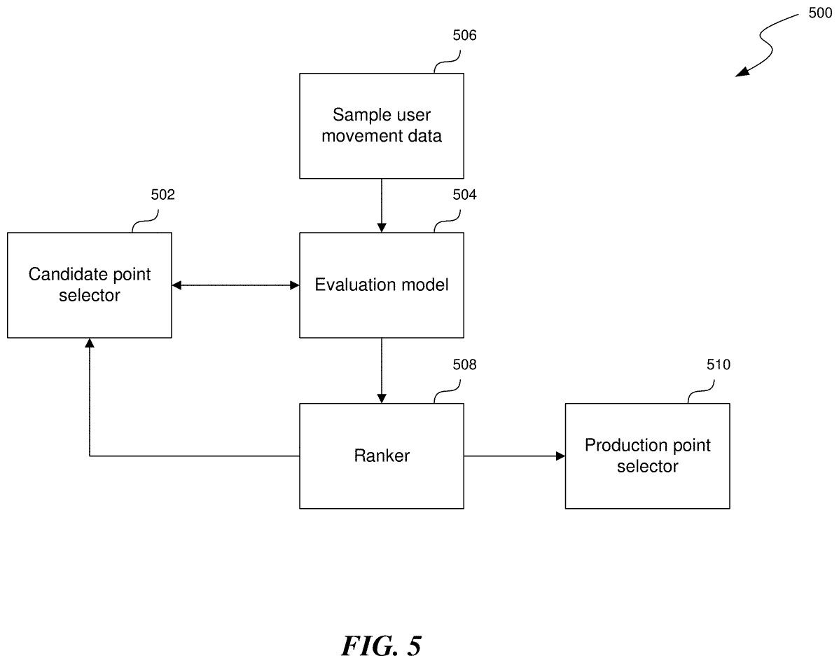

FIG. 5 depicts a system diagram of example components for evaluating and selecting movement points that support avatar movement in an artificial reality environment. System 500 includes candidate point selector 502, evaluation model 504, sample user movement data 506, ranker 508, and production point selector 510.

In some implementations, candidate point selector 502 can select a set of candidate movements points. The set of candidate movements points can represent points on a user's body that are tracked to sense user movement. The tracked points on the user's body can be mapped to candidate movements points on one or more body models of an avatar. The candidate movements points on the avatar body model(s) can be movement points used to move the avatar in a manner that simulates the tracked movement of the user's body.

The set of candidate movement points can be provided to evaluation model 504. Evaluation model 504 can be configured to generate an evaluation metric for the set of candidate movement points. For example, sample user movement data 506 can store historic tracked movement data for a user body. In some implementations, the historic tracked movement data includes movement data sensed/tracked for a global set of candidate movement points (e.g., the entire set of candidate movement points from which sets of candidate movement points are selected) during sample user body movements. In some implementations, sample user movement data 506 includes several batches of tracked data that correspond to different user movements and/or different user bodies.

Evaluation model 504 can generate avatar movement using the avatar's body model, sample user movement data 506, and one or more sets of movements points. For example, test avatar movement can be generated using the candidate set of movement points and a baseline avatar movement can be generated using the global set of movement points. The test avatar movement can then be compared to the baseline avatar movement to determine a fidelity for the test avatar movement. In this example, the movement generated using the global set of movement points can serve as a baseline for the sets of candidate movement points being evaluated.

For example, a difference in the test avatar movement and the baseline avatar movement can be calculated and stored. The difference can be a difference in smooth motion (e.g., distance moved over time) for parts of the avatar body, lost motion (e.g., movement from the second avatar movement lost in the first avatar movement), and any other suitable difference. The calculated difference can represent an avatar movement fidelity for the set of candidate movement points.

Evaluation model 504 can also generate a predicted computing resource utilization for the candidate set of movement points. Evaluation model 504 can generate the prediction according to a predicted resource utilization at a client device, such as an artificial reality client system. In some circumstances, a large number of candidate movement points can correspond to a larger volume of generated movement data and thus greater processing resources for generating corresponding avatar movements. In some implementations, the volume of movement data that corresponds to the candidate set of movement points (e.g., within the sample user movement data 506) and/or the number of candidate movement points can be used to generate the predicted resource utilization metric.

In another example, a degree of avatar movement can serve as a proxy for computing resource utilization. In some implementations, the total amount of avatar movement within the generated test avatar movement (e.g., generated using the set of candidate movement points) can be used to generate the predicted resource utilization metric. In another example, the computing resources used to generate the test movement using the set of candidate movement points and sample user movement data 506 can be used to generate the predicted resource utilization metric.

The fidelity metric and predicted resource utilization metric can be combined to generate an evaluation metric for the set of candidate movement points. For example, a mathematical operation can combine the fidelity metric and the predicted resource utilization metric, such as a sum, average, weighted average, or any other suitable mathematical operation.

In some implementations, evaluation model 504 can evaluate a set of candidate movement points using multiple avatar body models. For example, evaluation model 504 can generate first avatar body movement using a first avatar's body model, sample user movement data 506, and the set of candidate movement points, and second avatar body movement using a second avatar's body model, sample user movement data 506, and the set of candidate movement points. Evaluation model 504 can then generate evaluation metric(s) for each avatar body model, such as by comparing the first avatar body movement to a baseline avatar body movement for the first avatar body model and comparing the second avatar body movement to a baseline avatar body movement for the second avatar body model.

In some implementations, candidate point selector 502 can iteratively select different sets of candidate movement points and provide these sets to evaluation model 504. For example, the different sets of candidate movement points can include different numbers of candidate movements points, points at different locations, points distributed across the user body in different manners, and any other suitable differences. Evaluation model 504 can generate evaluation metric(s) for the sets of candidate movement points. Evaluation model 504 can provide ranker 508 with the sets of candidate movement points and the evaluation metric(s) generated for the sets of candidate movement points.

Ranker 508 can rank the sets of candidate movement points according to the generated evaluation metric(s). For example, the sets of candidate movement points can be ranked according to the fidelity metric, predicted resource utilization metric, a combination of these, or any other suitable evaluation metric. In some implementations, a first ranking can be generated for candidate sets of movement points (and corresponding evaluation metrics) for a first avatar body model and a second ranking can be generated for candidate sets of movement points (and corresponding evaluation metrics) for a second avatar body model. Ranker 508 can provide the rankings of the sets of candidate movement points to production point selector 510.

In some implementations, production point selector 510 can select one or more of the sets of candidate movements points for production. For example, the selected production movement points can be used to translate user body movement to avatar body movement when the user is interacting with an artificial reality device. The selected production movement points can be used for a number of different avatar body models, or different production movement points can be selected for different avatar body models. In some implementations, a highest ranked set of candidate movement points (e.g., within each ranking) can be selected for production.

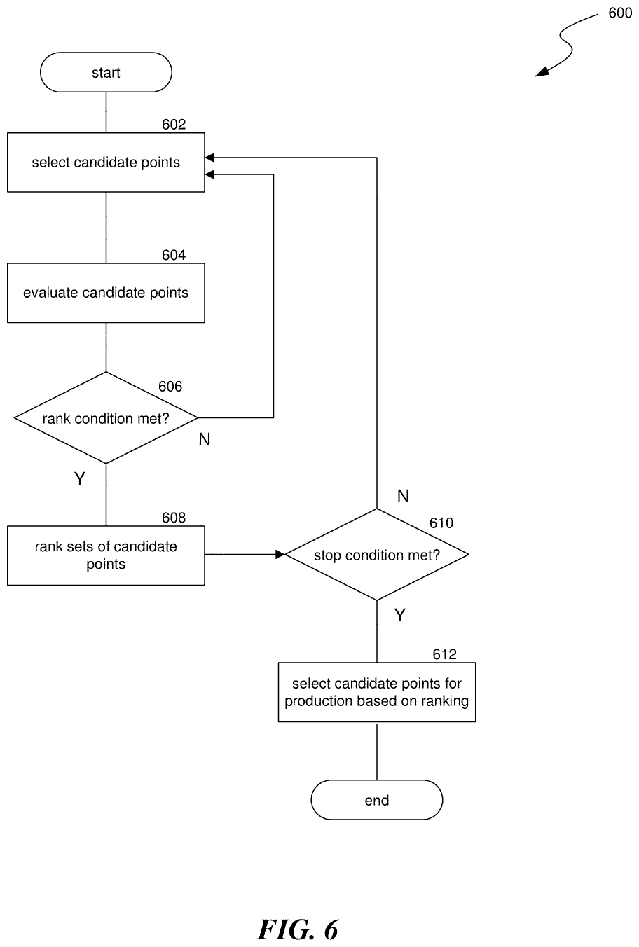

FIG. 6 is a flow diagram illustrating a process 600 used in some implementations for evaluating and selecting movement points that support avatar movement in an artificial reality environment. In some implementations, process 600 can be performed to configure or reconfigure a user's experience with an artificial reality environment.

At block 602, process 600 can select a set of candidate movement points. The set of candidate movements points can represent points on a user's body that are tracked to sense user movement. The tracked points on the user's body can be mapped to candidate movements points on one or more body models of an avatar. The candidate movements points on the avatar body model(s) can be movement points used to move the avatar in a manner that simulates the tracked movement of the user's body.

At block 604, process 600 can evaluate the set of candidate movement points. For example, the set of candidate movement points can be evaluated by generating avatar test movement according to the set of candidate movement points. The avatar test movement can be generated using stored historic movement data tracked/sensed from a user's body movements and a body model for the avatar. In some implementations, the test movement can be compared to baseline movement for the avatar (e.g., avatar's body model) to calculate a difference between the test movement and the baseline movement. A fidelity metric for the set of candidate movement points can be generated based on the calculated difference.

In some implementations, a predicted computing resource utilization can be generated for the candidate set of movement points. The volume of movement data that corresponds to the candidate set of movement points (within the stored historic movement data) and/or the number of candidate movement points can be used to generate the predicted resource utilization metric. In some implementations, the total amount of avatar movement within the generated test movement (e.g., generated using the set of candidate movement points) can be used to generate the predicted resource utilization metric. In another example, the computing resources used to generate the test movement using the sample set of movement points can be used to generate the predicted resource utilization metric. The fidelity metric and predicted resource utilization metric can be combined to generate an evaluation metric for the set of candidate movement points.

At block 606, process 600 can determine whether a rank condition has been met. For example, the rank condition can be met when a threshold number of sets of candidate movements points have been evaluated, when a sets of candidate movements points have at least minimum fidelity metric and/or maximum predicted computing resource utilization, etc. Any other suitable rank condition can be implemented.

When the rank condition has been met, process 600 can progress to block 608. When the rank condition has not been met, process 600 can loop back to block 602 for the selection of an additional set of candidate movement points and the evaluation of those points.

At block 608, process 600 can rank the sets of candidate movement points. The sets of candidate movement points can be ranked according to the fidelity metric, resource utilization metric, a combination of these, or any other suitable evaluation metric.

At block 610, process 600 can determine whether a stop condition has been met. For example, when a threshold number of sets of candidate movement points have been evaluated and ranked or a minimum rank value has been achieved, the stop condition may be met. In another example, if no additional sets of candidate movement points remain for evaluation, the stop condition may be met.

In some implementations, the stop criteria may be met when at least one set of candidate movement points meets an evaluation criteria. For example, the evaluation metrics generated for the sets of candidate movement points can be compared to one or more threshold levels. When at least one evaluated/ranked set of candidate movement points meets the threshold levels, the stop criteria may be met. When no set of candidate movement points meets the threshold levels, the stop criteria may not be met.

When the stop condition has been met, process 600 can progress to block 612. When the stop condition has not been met, process 600 can loop back to block 602 for the selection of additional sets of candidate movement points, the evaluation of those sets of candidate movement points, and the ranking of those sets of candidate movement points.

At block 612, process 600 can select one or more sets of candidate movement points for production according to the ranking(s). For example, the selected production movement points can be used to translate user body movement to avatar body movement when the user is interacting with an artificial reality device.

In some implementations, at block 602 different sets of candidate movement points can be selected, and these different sets of points can be evaluated at block 604. For example, the different sets of candidate movement points can include different numbers of candidate movements points, points at different locations, points distributed across the user body in different manners, and any other suitable differences. In some implementations, a selection criteria can be used to select the sets of candidate movement points, such as a minimum number of points, maximum number of points, core points (movement points that are maintained in each set of candidate movements points), and the like.

When process 600 returns to block 602 from block 610 (e.g., when a stop condition is not met), the selection criteria can be adjusted. For example, the minimum number of points can be increased or decreased, the maximum number of points can be increased or decreased, and/or the core points can be adjusted (e.g., movement points included in the core can be substituted, the number of movement points in the core points can be increased or decreased, etc.). In this example, at block 602 sets of candidate movement points can then be selected according to the adjusted selection criteria.

Implementations transition a user presence representation based on detection of one or more trigger conditions. For example, one or more cameras can capture a user stream of visual data (e.g., streaming video) that captures camera frames of the user. The user stream can be part of a shared communication session that includes several users, such as a video call, artificial reality session, and the like. The user's presence (i.e., how the user is depicted to other participants) in the shared communication session can be defined by user preferences and/or one or more trigger conditions. An example set of user presence types includes a two-dimensional still image, an avatar, a mini-avatar, a two-dimensional video, or three-dimensional hologram.

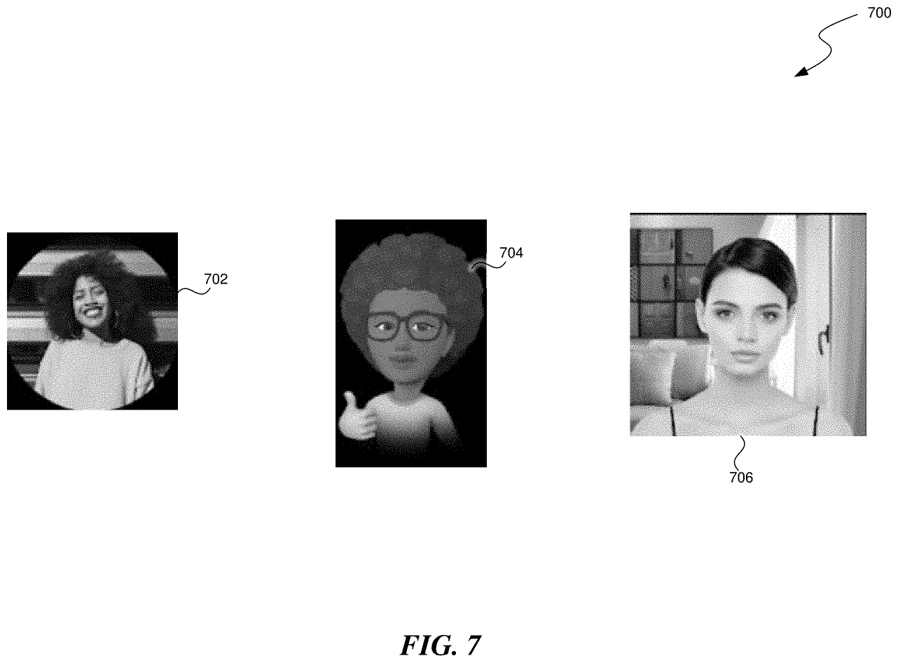

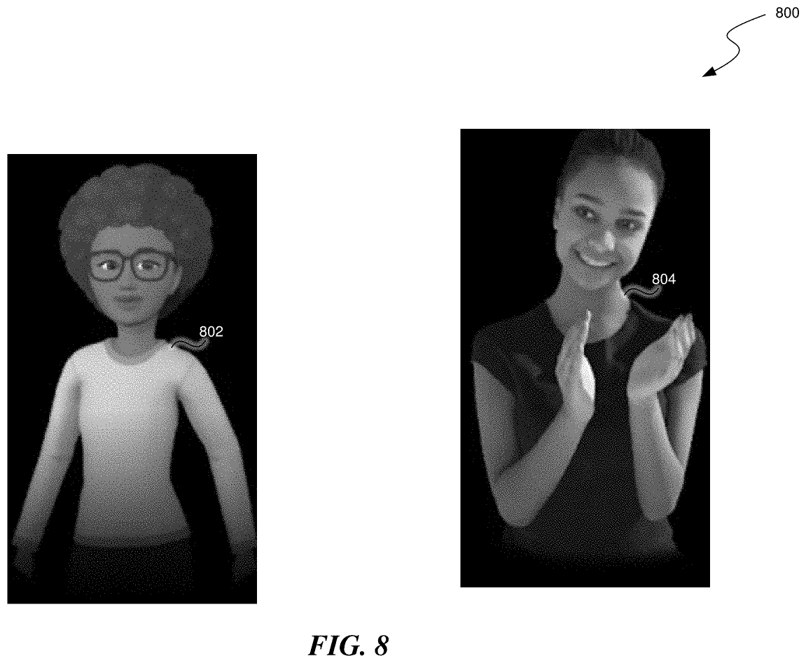

FIGS. 7 and 8 depict diagrams of example user presence representations.

Diagram 700 includes still image 702, mini-avatar 704, and two-dimensional video 706 user presence representations, and diagram 800 includes an avatar 802 and three-dimensional hologram video 804 user presence representations.

The user preferences may define the user's preferred visual presence types during a shared communication session. For example, a user preference may define that a first avatar (e.g., user customized avatar) should be used during a first shared communication session (e.g., virtual reality game), a three-dimensional hologram should be used during a first type of video call (e.g., personal video call), and a two-dimensional video with a virtual background should be used during a second type of video call (e.g., professional video call).

In some implementations, during these shared communication sessions, a presence manager can detect a trigger condition and transition from a first user presence (e.g., the user's preferred presence) to a second user presence. For example, the presence manager can compare one or more parameters to trigger condition definitions to detect the trigger condition. An example trigger condition definition includes the parameters for triggering the trigger condition and one or more transition actions for transitioning the user presence (e.g., transition to still image, transition from hologram presence to two-dimensional video, and the like).

An example trigger definition can be detection of portions of the user that are out of the field of view of one or more cameras that capture the user's stream. The user may be located within the field of view, and the presence manager may detect that movement from the user has caused a portion of the user's body to no longer be in the field of view. Based on detection of this example trigger condition, the presence manager can transition to an avatar representations for the portion(s) of the user that are not in frame (e.g., user's torso, arms, head, and the like), or transition entirely to an avatar user presence.

Another example trigger condition can be detection that the user is a threshold distance from the capture device (e.g., camera). For example, visual frames from the user stream can be processed to estimate the user's distance from the capture device. Upon detection of this example trigger, the presence manager can transition from a three-dimensional hologram presence to a two-dimensional video (or an avatar or mini-avatar presence) or reduce the fidelity of the user's hologram presence. Another example trigger condition can be detection that utilization metric for the user's computing system reaches a utilization threshold or a network bandwidth for the user's computing system reaches a bandwidth threshold. In this example, the capturing device (e.g., camera) can be part of a user system, such as a laptop, smartphone, AR system, or any other suitable system. A utilization metric for the user system, a network bandwidth for the user system, or a combination of these can be compared to a criteria for the trigger condition. Upon detection of this example trigger, the presence manager can transition from a three-dimensional hologram presence to a two-dimensional video (or an avatar or mini-avatar presence) or reduce the fidelity of the user's hologram presence.

Another example trigger condition can be detection that the user (e.g., user's system) is located in a predefined zone location that has as predetermined presence association (or a predetermined presence association with a type assigned to the zone). For example, visual frames from the user stream can be processed to determine that the user is located in her vehicle. A location for the user's system can also be compared to known locations (e.g., a geofence) to detect presence in a predefined zone. Upon detection of this example trigger, the presence manager can transition from the two-dimensional video presence or hologram video presence to a still image, avatar, or mini-avatar presence. In this example, the user may not want to be depicted on video given the user's current circumstances (e.g., driving in a car). Another example predefined zone can be detection of a bathroom-type location (e.g., based on video processing or geofence comparisons where the determination indicates the user is current in a zone of a given type). Upon detection of this example trigger, the presence manager can transition from the two-dimensional video presence, hologram video presence, or an avatar presence to a still image a still image, avatar presence, or mini-avatar presence, based on a mapping (general across users or created for a specific user) of the zone type to the presence type.

Another example trigger condition can be detection that the user is performing an activity with a predefined user presence association. For example, visual frames from the user stream can be processed to determine that the user is driving, exercising (e.g., running, cycling, and the like), or performing any other suitable activity that takes the user's attention. Upon detection of this example trigger, the presence manager can transition from the two-dimensional video presence, hologram video representation, or an avatar presence to a still image, avatar presence, or mini-avatar presence based on a mapping (general across users or created for a specific user) of identified activity to the presence type.

Implementations can perform video processing using one or more machine learning models, such as a convolutional neural network. For example, a machine learning model can be trained to detect locations or location types of a current user. In another example, a machine learning model can be trained to predict an activity being performed by the user. In another example, a machine learning model can be trained to predict the user's distance from a camera. A single machine learning model can be trained to perform one or more of these example functions.

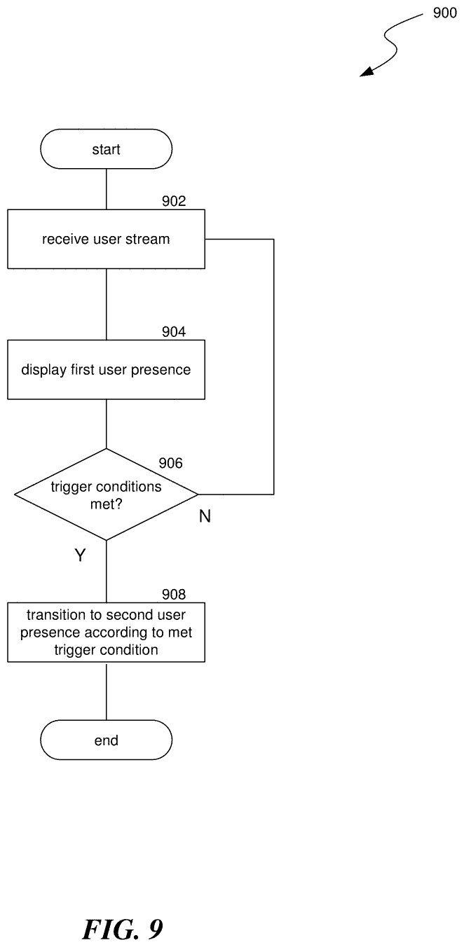

FIG. 9 is a flow diagram illustrating a process 900 used in some implementations for detecting trigger conditions and transitioning a user presence in a shared communication session. In some implementations, process 900 can be performed during a shared communication session (e.g., a video call, an artificial reality session, and the like). In some implementations, process 900 can transition from a first user presence within the shared communication session to a second user presence in real-time.

At block 902, process 900 can receive a user stream that includes visual data of a first user. For example, the user stream can be captured by a user computing system that includes one or more cameras. The user stream can be part of a shared communication session that includes multiple users, such as a video call, artificial reality session, and the like.

At block 904, process 900 can display a first user presence of the first user within the shared communication session. For example, the first user can be displayed to the multiple users that are part of the shared communication session as the first user presence. Examples of the first user presence include a two-dimensional still image, an avatar, a mini-avatar, a two-dimensional video, a three-dimensional hologram, or any combination thereof.

At block 906, process 900 can determine whether a trigger condition has been met. For example, parameters for the user computing system and/or captured visual data of the first user within the user stream can be compared to trigger definitions to determine whether any trigger conditions have been met. A trigger condition can be detected when: a) the first user is a threshold distance from the camera; b) a portion of the first user is out of a field of view of the camera; c) a location for the user computing system is within a predefined zone or type of zone; d) a resource utilization of the user computing system meets a utilization criteria; e) the user computing system's data network bandwidth meets a bandwidth criteria; f) the user is determined to be performing a particular activity; or any combination thereof. Process 900 can progress to block 908 when a trigger condition is met. Process 900 can loop back to block 902 when the trigger condition is not met, where the user stream can continue to be received.

At block 908, process 900 can transition the display of the first user within the shared communication session from the first user presence to a second user presence. For example, the met trigger condition can include a definition that defines parameters for meeting the trigger condition and which user presence to transition to upon detection of the trigger condition. Examples of the second user presence include a two-dimensional still image, an avatar, a mini-avatar, a two-dimensional video, a three-dimensional hologram, or any combination thereof. In some implementations, the transition from the first user presence to the second user presence occurs in real-time during the shared communication session.

Users are often represented in XR environments (e.g., a social network, a messaging platform, a game, or a 3D environment) by graphical representations of themselves, such as avatars. In some cases, it may be desirable to have an avatar's characteristics be similar to the likeness of its corresponding user, such that the user can be identified by others based on the avatar's visual appearance in the XR environment. While some systems enable a user to manually configure their avatar's characteristics, it can be difficult to closely match the appearance of a person with a limited set of available characteristic combinations. While it is possible to manually create a highly personalized avatar of a person, doing so can be a labor-intensive process that requires a specialized set of modeling skills. Moreover, aspects of a person's appearance may change over time (e.g., hair color, hair style, accessories, clothing, etc.), such that any manually-created avatar at the time it was created might not reflect a person's appearance at a later time.

Aspects of the present disclosure are directed to generating stylized three-dimensional (3D) avatars based on two-dimensional (2D) images of a person using a pipeline of one or more computational transformations. In an example embodiment, a stylized avatar generation pipeline includes a style transfer model (e.g., a generative adversarial network (GAN), a convolutional neural network (CNN), etc.) which transforms an input 2D image or photograph of a person into a stylized representation of that person. The stylized avatar generation pipeline also includes a depth estimation module that is trained to generate a depth map based on the stylized 2D image of the person (e.g., a monocular depth estimation model, a facial keypoint detection model, etc.). By combining the stylized 2D image with the generated depth map, the stylized avatar generation pipeline can output a stylized 3D avatar.

As described herein, a “stylized” representation of an object or person generally refers to a non-photorealistic or artistic version of that object or person, which possesses at least some characteristics or features in common with the original image of the photo or person. In some embodiments, the stylized version of a person may be generated based on a latent space representation of that person (e.g., features extracted when reducing the dimensionality of an input image). The layer from which the latent vector is selected may be determined by providing multiple possible latent vectors as inputs to a GAN model and selecting the latent vector which generates an image of the person that closely resembles the original input image. Once the latent space representation (also referred to as the “latent vector”) of the person is selected, a semantic space for a particular style may be used to generate a stylized version of the person from the latent vector.

A style transfer model may be any type of machine learning model that is trained to receive an input image of an object or person and generate an output image representing the object or person in a stylized or artistic form. In some implementations, the style transfer model may include a GAN that is trained to map a latent space vector representing of person's features to an intermediate latent space vector. The style transfer model may be trained with a curated data set containing images of a particular artistic style, such that an image generated from the transformed latent space vector retains characteristics of the person and matches the aesthetic qualities of the particular artistic style (e.g., an artistic style associated with a particular artist, studio, brand, etc.). In other implementations, a style transfer model may apply a particular artistic style to a source image to generate a “pastiche” or altered version of the source image which blends the features of the source image with aspects the particular artistic style.

As described herein, a depth estimation module may include any combination of computer vision algorithms and/or machine learning models that infers a third dimension of information (e.g., distance, depth, etc.) from 2D image. An example depth estimation module for a person's bust or face may first perform facial keypoint detection to identify the locations of various facial features (e.g., eyes, nose, mouth, etc.). Based on the identified facial keypoints, the depth estimation module may then compute a depth map associating at least some of the pixels of the 2D image with a value representing the relative depth of that pixel or pixels. By combining the depth map with the 2D image, a 3D avatar may be generated. For example, polygons or surfaces may be generated by a graphical engine or the like to render a 3D avatar for a game, virtual video call, or another XR environment. In some cases, the depth estimation module may generate the 3D avatar as a 3D object, while in other cases the depth estimation module simply infers the depth information from a 2D image.

In some implementations, the depth estimation module may be specifically designed or trained to infer depth according to a particular artistic style. For instance, one artistic style may exaggerate certain facial features (e.g., large eyes, large nose, rounder cheeks, etc.). The depth estimation module may be tuned to generate depth information that matches that artistic style, which may vary to some extent from depth information that might otherwise be inferred if the module were tuned to generate depth information in a photorealistic manner. Some artistic styles may generate very smooth or high-resolution depth maps, while others may generate more “blocky” or low-resolution depth maps (e.g., a 3D comic book style sometimes described as “cel-shading”).

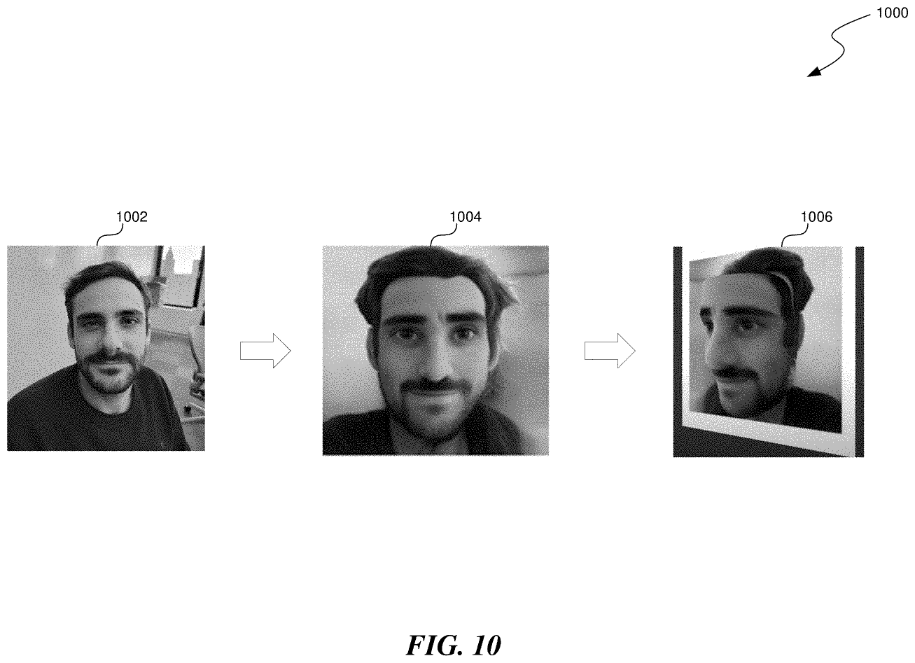

A 3D avatar of a person's face or bust may be generated from at least one 2D image or photograph of that person, examples of which are depicted in FIGS. 10-12. FIG. 10 is a conceptual diagram illustrating an example transformation 1000 of an image 1002 of a user to a stylized 3D avatar 1006. The example transformation 1000 may first convert the image 1002 of the user into a stylized image 1004 using a style transfer model. In this example, the style transfer model was trained with an image data set of a particular “cartoon” style. The 2D avatar of the person depicted in the “cartoon” stylized image 1004 possesses similar characteristics as the person depicted in image 1002 (e.g., facial hair style, skin tone, eye color, shirt color and style, etc.), such that someone familiar with the person depicted in image 1002 might be able to determine the identity of that person based on the appearance of their stylized 2D avatar depicted in the stylized image 1004. In addition, a person familiar with the particular artistic style of the style transfer model might also be able to identify the source of the style represented in the stylized image 1004.

The transformation 1000 also includes a depth estimation module, which is used to generate the 3D stylized avatar 1006 based on the 2D stylized image 1004. The depth estimation module may perform facial keypoint detection to identify the locations of various facial features. The depth estimation module may then infer depth information based on the facial keypoints. The transformation 1000 may combine the depth information with the 2D stylized image 1004 to generate the stylized 3D avatar 1006. In this manner, a 3D avatar resembling a particular person in a particular artistic style is generated without the need for a labor-intensive process by a skilled artist.

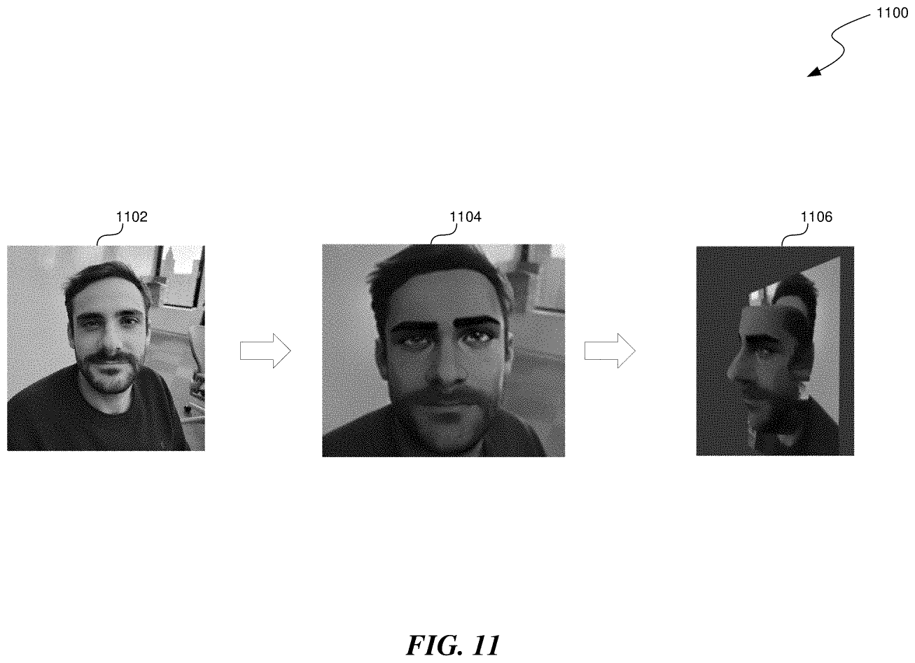

FIG. 11 is a conceptual diagram illustrating an example transformation 1100 of an image 1102 of a user to a stylized 3D avatar 1106, which involves a similar set of transformations as those shown and described with respect to FIG. 10. However, in this example, the style transfer model was trained with an image data set of a particular “comic book” or “cel-shaded” style, such that the stylized 2D image 1104 possesses characteristics of a paper sketch or painting. The transformation pipelines described herein may accordingly be used to automatically generate 3D avatars in different artistic styles.

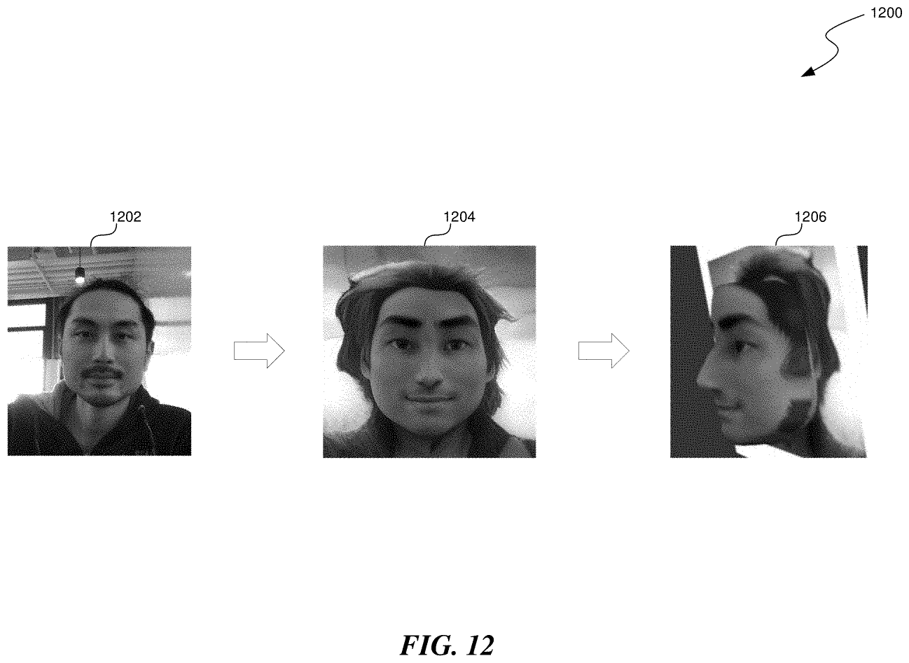

FIG. 12 is a conceptual diagram illustrating an example transformation 1200 of an image 1202 of a user to a stylized 3D avatar 1206, which involves a similar set of transformations as those shown and described above. The stylized 2D image 1204 of FIG. 12 was generated using the same style transfer model as discussed above, such that the respective 2D avatars possess some common characteristics (e.g., round cheeks, enlarged eyes, exaggerated eyebrows, etc.). Accordingly, the transformation pipelines described herein may be used to automatically generate multiple 3D avatars in the same artistic style.

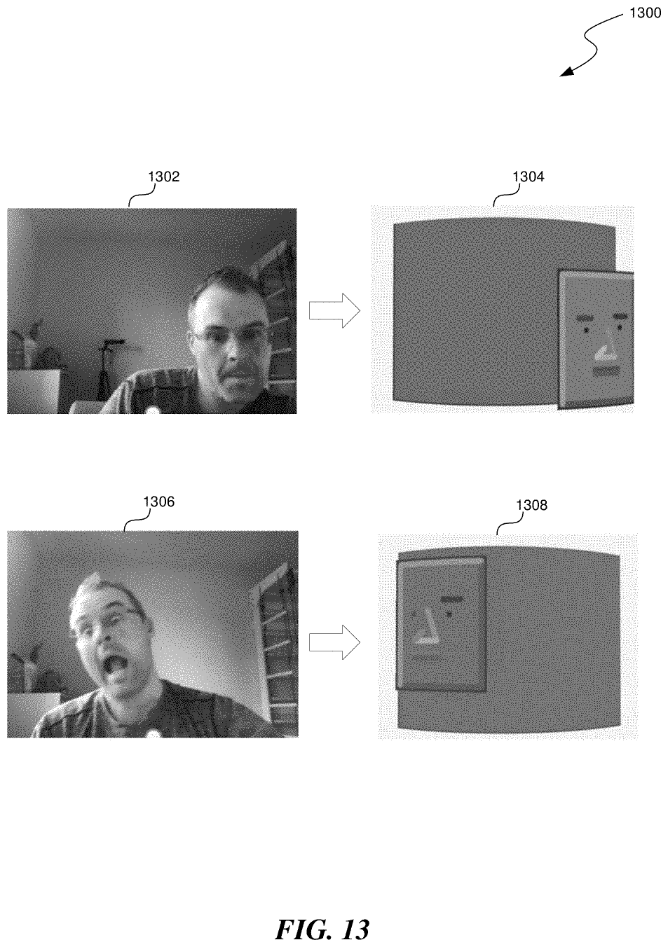

In some embodiments, the 3D avatar generation pipeline may produce stylized 3D avatars with a non-human appearance, such as a robot or a block figure. Such pipelines may include one or more transformations that extract features of a person depicted in a 2D image (e.g., skin tone, eyebrow geometry, mouth shape, eye openness, overall facial expression, etc.), which are then used to generate a 3D representation of that person in a virtual environment. In addition, such pipelines may determine the relative location of the person within the field-of-view (FOV) of a camera, and translate that location to a corresponding location within the virtual environment. FIG. 13 is a conceptual diagram illustrating example transformations 1300 of images 1302 and 1306 of a user to stylized 3D avatars 1304 and 1308, respectively, according to this embodiment.

One of the transformations 1300 involves extracting features from an image 1302 of a person, and the relative location of the person in the image 1302. These features are then used to generate a stylized avatar 1304. An example implementation may use style transfer model trained to generate block figures, such as the one shown as the stylized avatar 1304. In other implementations, a parameterized 3D model of a block figure may be configured based on the extracted features and location of the person in the image 1302.

The person in the image 1306 has a different facial expression and is in a different location compared to the person in the image 1302, causing the avatar generation pipeline to produce a stylized avatar 1308 at a different location and with a different facial expression. Depending on the particular implementation, this avatar generation pipeline may be less computationally expensive, enabling “just in time” or near real time execution on a user's computing device, such that the 3D stylized avatar can be updated live in an XR environment in response to a user's movement and change in facial expressions.

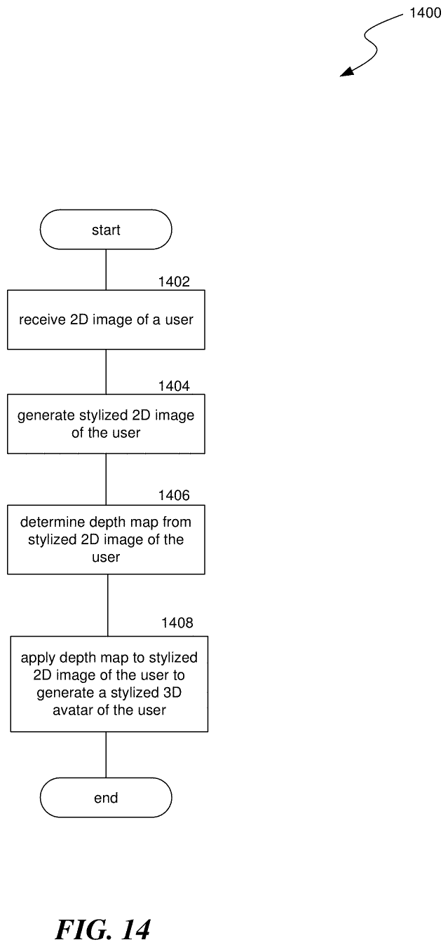

FIG. 14 is a flow diagram illustrating a process 1400 used in some implementations of the present technology for generating stylized 3D avatars. In some implementations, process 1400 can be performed on an artificial reality device, e.g., by a sub-process of the operating system, by an environment control “shell” system, or by an executed application in control of displaying one or more person objects in an artificial reality environment. The process 1400 is an example process for generating the stylized 3D avatars as discussed above.

At block 1402, process 1400 can receive a 2D image of a user. The 2D image of the user may be captured by a user's smartphone, webcam, or another camera. The image data is provided as an input to the process 1400, which in turn is provided as an input to a 3D avatar generation pipeline. In some embodiments, block 1402 may include an image capture operation whereby the process 1400 instructs a user to capture a self-portrait image at a preferred distance and with a preferred orientation with respect to the camera (e.g., at a distance and orientation that is similar to the image data set used to train the style transfer model and/or the depth estimation module).

At block 1404, process 1400 can generate a stylized 2D image of the user using a style transfer model or the like. Block 1404 may include multiple sub-steps, such as the process 1400 first extracting a latent space vector representation of the person depicted in the 2D image and the process 1400 subsequently generating the stylized 2D image based on the extracted latent space vector.

At block 1406, process 1400 can determine a depth map from the stylized 2D image of the user. Block 1406 may include multiple sub-steps, such as the process 1400 first performing facial keypoint extraction, and then the process 1400 inferring depth information based on a depth model trained to infer a topology based on facial keypoints. In some implementations, the process 1400 may determine depth information using a monocular depth estimation model, which may not necessarily perform facial keypoint extraction to estimate depth, for example the model can estimate a depth value for each pixel in an area of the image identified as depicting a person's face.

At block 1408, process 1400 can apply the depth map to the stylized 2D image of the user to generate a stylized 3D avatar of the user. In some implementations, the depth map may include depth values associated with each individual pixel of the stylized 2D image, such that the process 1400 can depict the stylized 3D avatar by rendering it in a 3D virtual environment. In other implementations, the depth map may be at a different or lower resolution than that of the stylized 2D image. In such implementations, the process 1400 may generate polygons or surfaces that span across various 3-point sets of the depth points (e.g., x- and y-values from a corresponding pixel location, and a z-value from the depth information), which are collectively rendered to create a 3D representation of the stylized 2D avatar. In yet other implementations, the process 1400 might associate each depth location with a corresponding pixel in the stylized 2D image, which may then be stored as a 3D model for rendering in 3D virtual environment at a later time.

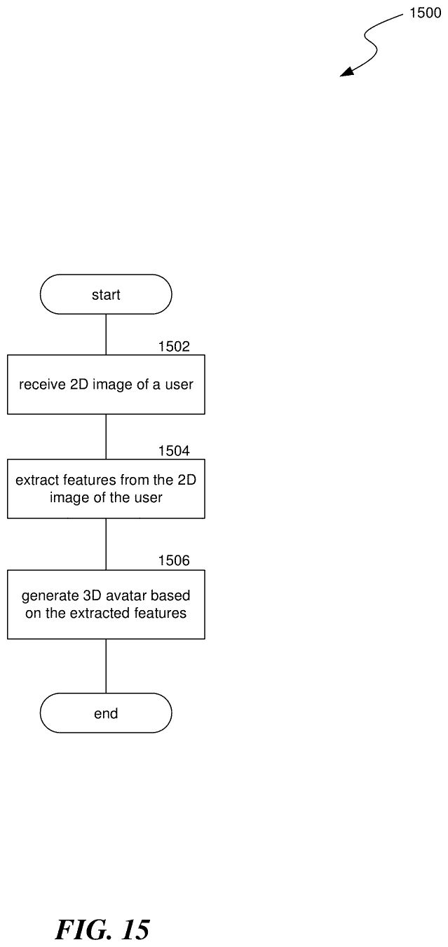

FIG. 15 is a flow diagram illustrating a process 1500 used in some implementations of the present technology for transferring user characteristics to a stylized 3D avatars. In some implementations, process 1500 can be performed on an artificial reality device, e.g., by a sub-process of the operating system, by an environment control “shell” system, or by an executed application in control of displaying one or more person objects in an artificial reality environment. The process 1500 is an example process for generating the stylized 3D avatars 1304, 1308 as shown and described with respect to FIG. 13. The process 1500 may use less computationally-expensive transformations than process 1400, such that the process 1500 can be performed in near-real time (e.g., for video calls, VR video games, etc.).

At block 1502, process 1500 can receive a 2D image of a user. The process 1500 may, for example, extract the 2D image of the user from a video stream from a web cam. Alternatively, the process 1500 may receive an image of a user captured by a separate process or device.

At block 1504, process 1500 can extract features from the 2D image of the user. The process 1500 may use computer vision algorithms, machine learning models, or some combination thereof to extract relevant features from the user's face (e.g., features that may be provided as inputs to a 3D avatar generation model and/or parameters of an existing 3D character model).

At block 1506, process 1500 can generate a 3D avatar based on the extracted features. In some implementations, the process 1500 generates the 3D avatar using a machine learning model. In other implementations, the process 1500 instantiates the 3D avatar based on an existing 3D character model, where one or more of the 3D character model's characteristics are adjustable parameters (e.g., skin tone, eyebrow orientation, mouth shape, etc.).

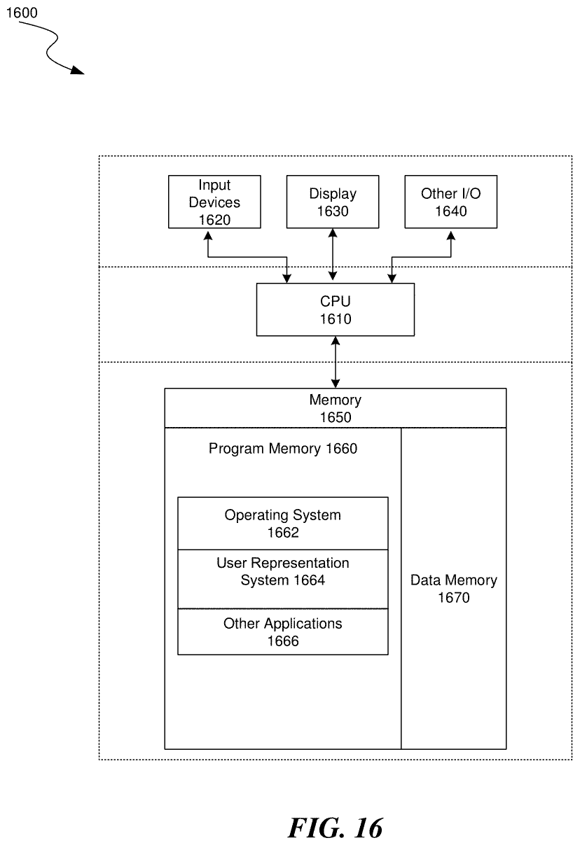

FIG. 16 is a block diagram illustrating an overview of devices on which some implementations of the disclosed technology can operate. The devices can comprise hardware components of a device 1600 as shown and described herein. Device 1600 can include one or more input devices 1620 that provide input to the Processor(s) 1610 (e.g., CPU(s), GPU(s), HPU(s), etc.), notifying it of actions. The actions can be mediated by a hardware controller that interprets the signals received from the input device and communicates the information to the processors 1610 using a communication protocol. Input devices 1620 include, for example, a mouse, a keyboard, a touchscreen, an infrared sensor, a touchpad, a wearable input device, a camera- or image-based input device, a microphone, or other user input devices.

Processors 1610 can be a single processing unit or multiple processing units in a device or distributed across multiple devices. Processors 1610 can be coupled to other hardware devices, for example, with the use of a bus, such as a PCI bus or SCSI bus. The processors 1610 can communicate with a hardware controller for devices, such as for a display 1630. Display 1630 can be used to display text and graphics. In some implementations, display 1630 provides graphical and textual visual feedback to a user. In some implementations, display 1630 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1640 can also be coupled to the processor, such as a network card, video card, audio card, USB, firewire or other external device, camera, printer, speakers, CD-ROM drive, DVD drive, disk drive, or Blu-Ray device.

In some implementations, the device 1600 also includes a communication device capable of communicating wirelessly or wire-based with a network node. The communication device can communicate with another device or a server through a network using, for example, TCP/IP protocols. Device 1600 can utilize the communication device to distribute operations across multiple network devices.

The processors 1610 can have access to a memory 1650 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1650 can include program memory 1660 that stores programs and software, such as an operating system 1662, User Representation System 1664, and other application programs 1666. Memory 1650 can also include data memory 1670, which can be provided to the program memory 1660 or any element of the device 1600.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

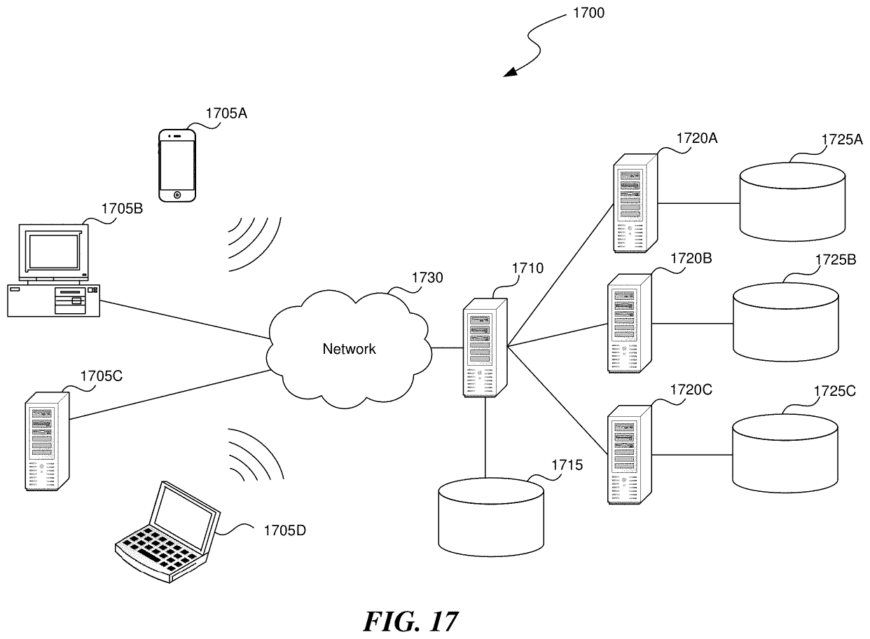

FIG. 17 is a block diagram illustrating an overview of an environment 1700 in which some implementations of the disclosed technology can operate. Environment 1700 can include one or more client computing devices 1705A-D, examples of which can include device 1600. Client computing devices 1705 can operate in a networked environment using logical connections through network 1730 to one or more remote computers, such as a server computing device.

In some implementations, server 1710 can be an edge server which receives client requests and coordinates fulfillment of those requests through other servers, such as servers 1720A-C. Server computing devices 1710 and 1720 can comprise computing systems, such as device 1600. Though each server computing device 1710 and 1720 is displayed logically as a single server, server computing devices can each be a distributed computing environment encompassing multiple computing devices located at the same or at geographically disparate physical locations. In some implementations, each server 1720 corresponds to a group of servers.

Client computing devices 1705 and server computing devices 1710 and 1720 can each act as a server or client to other server/client devices. Server 1710 can connect to a database 1715. Servers 1720A-C can each connect to a corresponding database 1725A-C. As discussed above, each server 1720 can correspond to a group of servers, and each of these servers can share a database or can have their own database. Databases 1715 and 1725 can warehouse (e.g., store) information. Though databases 1715 and 1725 are displayed logically as single units, databases 1715 and 1725 can each be a distributed computing environment encompassing multiple computing devices, can be located within their corresponding server, or can be located at the same or at geographically disparate physical locations.

Network 1730 can be a local area network (LAN) or a wide area network (WAN), but can also be other wired or wireless networks. Network 1730 may be the Internet or some other public or private network. Client computing devices 1705 can be connected to network 1730 through a network interface, such as by wired or wireless communication. While the connections between server 1710 and servers 1720 are shown as separate connections, these connections can be any kind of local, wide area, wired, or wireless network, including network 1730 or a separate public or private network.

In some implementations, servers 1710 and 1720 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, the following:

A method for generating a stylized 3D avatar from a 2D image, the method comprising: receiving a first image of a user; generating, by a style transfer model, a second image of the user, wherein the second image is a stylized version of the user; determining, by a depth estimation module, depth map based on the second image of the user; and applying the depth map to the second image of the user to generate a stylized 3D model representative of the user.

I/We claim:

1. A method for causing an ambient avatar to perform physical interactions, the method comprising:
obtaining a status of a first user represented by the ambient avatar and/or a context of a second user viewing the ambient avatar;
selecting one or more rules with parameters that match value types in the status and/or context; and
executing the selected one or more rules, which cause the ambient avatar to perform a corresponding physical action.

2. A method for evaluating and selecting one or more sets of movements points for avatar movement, the method comprising:
generating sets of candidate movements points for one or more avatar body models;
evaluating the sets of candidate movements points according to an avatar movement fidelity and a predicted computing resource utilization, wherein the evaluating comprises generating one or more evaluation metrics for the sets of candidate movement points;
ranking the sets of candidate movement points according to the one or more evaluation metrics; and
selecting one or more sets of candidate movement points for production according to the ranking.

3. The method of claim 2, wherein sets of candidate movements points are generated for multiple avatar body models, at least one set of candidate movements points is selected for production for a first avatar body model, and at least one set of candidate movements points is selected for production for a second avatar body model.

4. A method for triggering a transition of a user presence during a shared communication session, the method comprising:
receiving visual data of a first user captured by one or more cameras, wherein the first user is displayed using a first presence in relation to the visual data;
detecting a trigger condition for transitioning the display of the first user; and
in response to detecting the trigger condition, transitioning the display of the first user from the first user presence to a second user presence.

5. The method of claim 4, wherein the trigger condition is detected when: a) the first user is a threshold distance from the camera; b) a portion of the first user is out of a field of view of the camera; c) a location for a computing device that captures the user stream is within a predefined zone or zone type; d) resource utilization of the computing device meets a utilization criteria; e) the computing device's data network bandwidth meets a bandwidth criteria; f) a user activity matching a set of pre-determined activities is detected; or any combination thereof.

6. The method of claim 4, wherein the visual data is for a shared communication session which is a video call or artificial reality session.

7. The method of claim 4, wherein the first user presence comprises one or more of an avatar, a mini-avatar, a two-dimensional video, a hologram representation, a two-dimensional still image, or any combination thereof.
